(19) United States
(12) Patent Application Publication
(10) Pub. No.: US 2005/0258207 A1
(43) Pub. Date: Nov. 24, 2005

(54) Motorcycle caddy

(76) Inventor: Stephen G. Sadler, Farmington Hills, MI (US)

Correspondence Address: JAMES RAY & ASSOCIATES, 2640 PITCAIRN ROAD, MONROEVILLE, PA, 15146, US

(21) Appl. No.: 11/113,610

(22) Filed: Apr. 25, 2005

Related U.S. Application Data
(60) Provisional application No. 60/572,262, filed on May 18, 2004.

(51) Int. Cl. B62J 7/00; B62J 9/00

(52) U.S. Cl. 224/413; 224/423

(57) ABSTRACT

An apparatus engageable with a motorcycle for supporting and carrying a golf bag. The apparatus comprises a pair of structural members, each having a substantially horizontally disposed portion engageable with a respective rear side portion of such motorcycle and a pair of substantially vertically disposed portions. There is a box like member having a bottom portion, a front portion and a pair of side portions for retaining such bag, such side portions engageable with the pair of substantially vertically disposed portions of the structural member and a means for supporting an upper portion of such golf bag. The means is engageable with a seat back of such motorcycle.

### CROSS REFERENCE TO RELATED APPLICATIONS

This application is closely related to and claims benefit from U.S. Provisional Application Ser. No. 60/572,262 filed on May 8, 2004.

### FIELD OF THE INVENTION

The present invention relates, in general, to an apparatus, used in transporting a golf bag, and more particularly, the present invention relates to an apparatus designed to be mounted on the back of a motorcycle for transporting such golf bag.

### BACKGROUND OF THE INVENTION

When a golfer wishes to go golfing the golfer must be able to transport his golf bag with clubs to the golf course. People driving cars do not encounter any problem since virtually all automobiles have sufficient room that the addition of a golf bag does not present a problem. However, people who drive motorcycles are presented with a problem, particularly on days when the weather is nice. Many motorcycle riders who enjoy riding their bike but have been forced to make a decision as to, do I want to go golfing or do I want to ride my motorcycle? It would be desirable if there were a means to carry the golf bag on the back of the motorcycle so that the golfer would not have to make a choice but could do both at the same time.

### SUMMARY OF THE INVENTION

In a first aspect the present invention provides an apparatus engageable with a motorcycle for supporting and carrying a golf bag. The apparatus comprises a pair of structural members, each one of the structural members having a substantially horizontally disposed portion engageable with a respective rear side portion of such motorcycle and a pair of substantially vertically disposed portions. There is a box like member having a bottom portion for supporting a bottom of such golf bag, a front portion for partially retaining such golf bag adjacent a bottom portion thereof and a pair of side portions engageable with the pair of substantially vertically disposed portions of the structural member, such golf bag being further retained adjacent such bottom portion thereof by at least one of the pair of substantially vertically disposed portions of the pair of structural members and the pair of side portions of the box like member serving to retain such bottom portion of such golf bag, and by at least one of the pair of substantially vertically disposed portions of the pair of structural members and at least one of the pair of side portions of the box like member serving to retain such bottom portion of such golf bag and a means for supporting an upper portion of such golf bag. The means is engageable with a seat back of such motorcycle.

In another aspect the present invention provides an apparatus engageable with a motorcycle for supporting and carrying a golf bag. The apparatus comprises a pair of structural members, each one of the structural members having a substantially horizontally disposed portion engageable with a respective rear side portion of such motorcycle and a pair of substantially vertically disposed portions. There is a box like member having a bottom portion for supporting a bottom of such golf bag, a front portion for partially retaining such golf bag adjacent a bottom portion thereof and a pair of side portions engageable with the pair of substantially vertically disposed portions of the structural member, such golf bag being further retained adjacent such bottom portion thereof by at least one of the pair of substantially vertically disposed portions of the pair of structural members and the pair of side portions of the box like member serving to retain such bottom portion of such golf bag, and by at least one of the pair of substantially vertically disposed portions of the pair of structural members and at least one of the pair of side portions of the box like member serving to retain such bottom portion of such golf bag and a means for supporting an upper portion of such golf bag. Such means including a generally U-shaped member, at least one leg of the U-shaped member angularly positioned between one of the pair of substantially vertically disposed portions of the structural member and adjacent an outer surface of the at least one of pair of substantially vertically disposed portions of pair of structural members for engagement with an upper portion of such golf bag.

### OBJECTS OF THE INVENTION

It is, therefore, one of the primary objects of the present invention to provide an apparatus that can be mounted on the back of a motorcycle that can be used to carry a golf bag.

Another object of the present invention is to provide an apparatus which can be used to carry a golf bag on the back of a motorcycle that can be installed easily.

Yet, another object of the present invention is to provide an apparatus which can be used to carry a golf bag on the back of a motorcycle which can be removed quickly.

Still another object of the invention is to provide an apparatus which can be used to carry a golf bag on the back of a motorcycle which will mount on the center line of the motorcycle.

Another object of the present invention is to provide an apparatus which can be used to carry a golf bag on the back of a motorcycle which will not affect the handling of the motorcycle.

Yet, another object of the present invention is to provide an apparatus which can be used to carry a golf bag on the back of a motorcycle which can be used on motorcycles with or without seat backs.

In addition to the various objects and advantages of the invention which have been described in some specific detail above it should be noted that various other objects and advantages of the present invention will become more readily apparent to those persons who are skilled in the relevant art from the following more detailed description, particularly, when such description is taken in conjunction-with the attached drawing Figures and with the appended claims.

### BRIEF DESCRIPTION OF THE DRAWINGS

FIG. 1 is a partial perspective view from the side of the apparatus according to an embodiment of the invention.

FIG. 2 is a side elevation view of the apparatus as attached to a seat back.

FIG. 3 is a partial perspective view from the front of the apparatus according to an alternate embodiment of the invention.

FIG. 4 is a partial perspective view of the apparatus shown in FIG. 1 as it is in place on a motorcycle.

FIG. 5 is a partial perspective view of the apparatus shown in FIG. 3 as it is in place on a motorcycle.

FIG. 6 is a partial perspective view of part of the apparatus showing a wire harness for connection with such vehicle=s lights.

FIG. 7 is a partial perspective view from the side of the apparatus according to an embodiment of the invention.

FIG. 8 is a partial perspective view from the side of the apparatus according to an alternate embodiment of the invention.

FIG. 9 is a partial perspective view from the side of the apparatus according to another alternate embodiment of the invention.

### BRIEF DESCRIPTION OF THE PRESENTLY PREFERRED AND VARIOUS ALTERNATIVE EMBODIMENTS OF THE INVENTION

Prior to proceeding to the more detailed description of the invention, it should be noted that identical components having identical functions have been designated with identical reference numerals throughout the several views illustrated in the drawings for the sake of clarity.

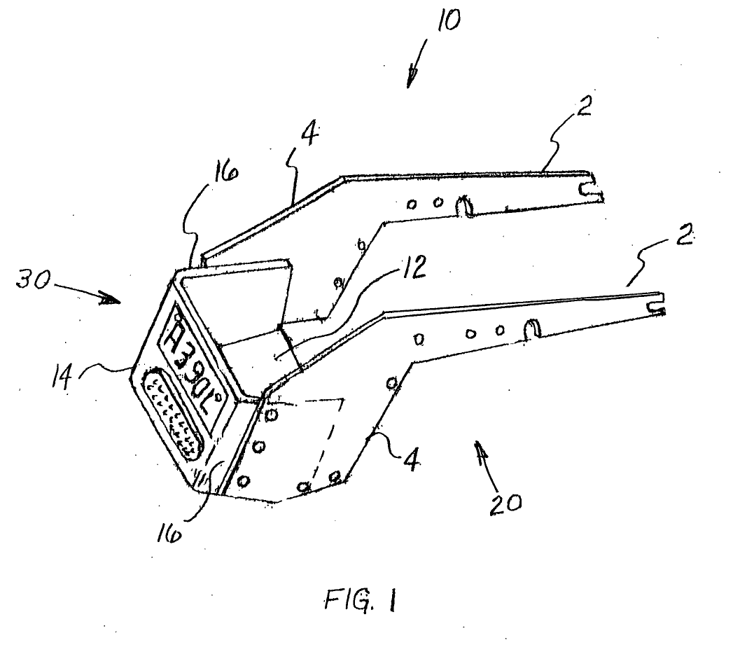

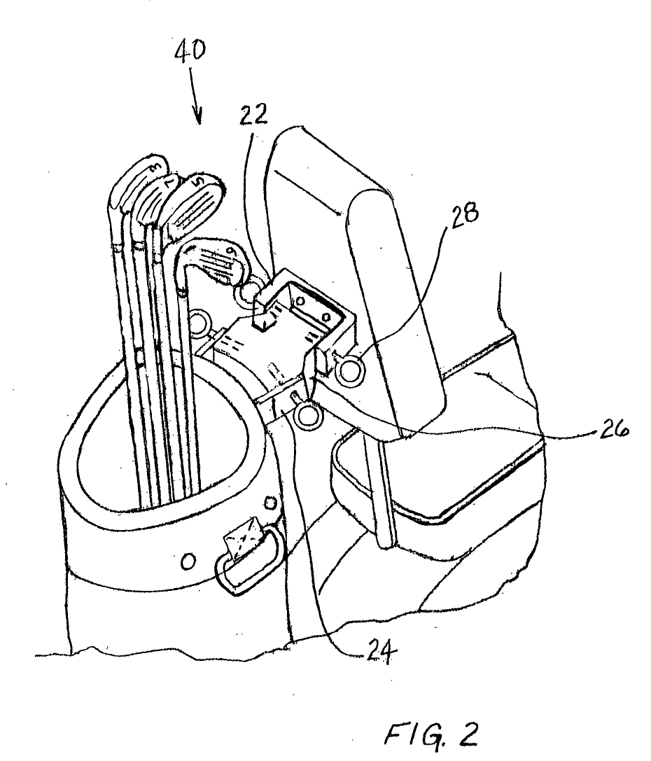

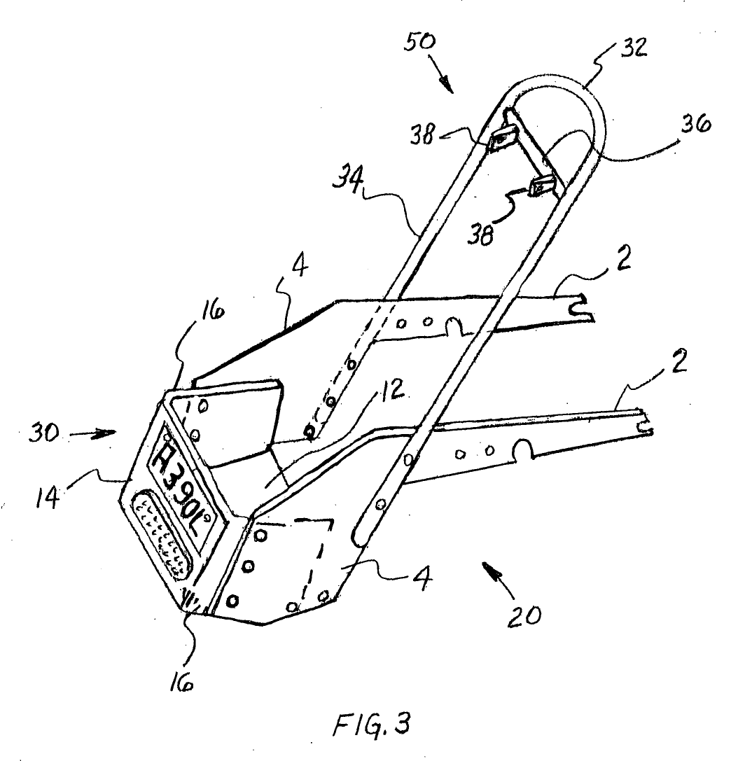

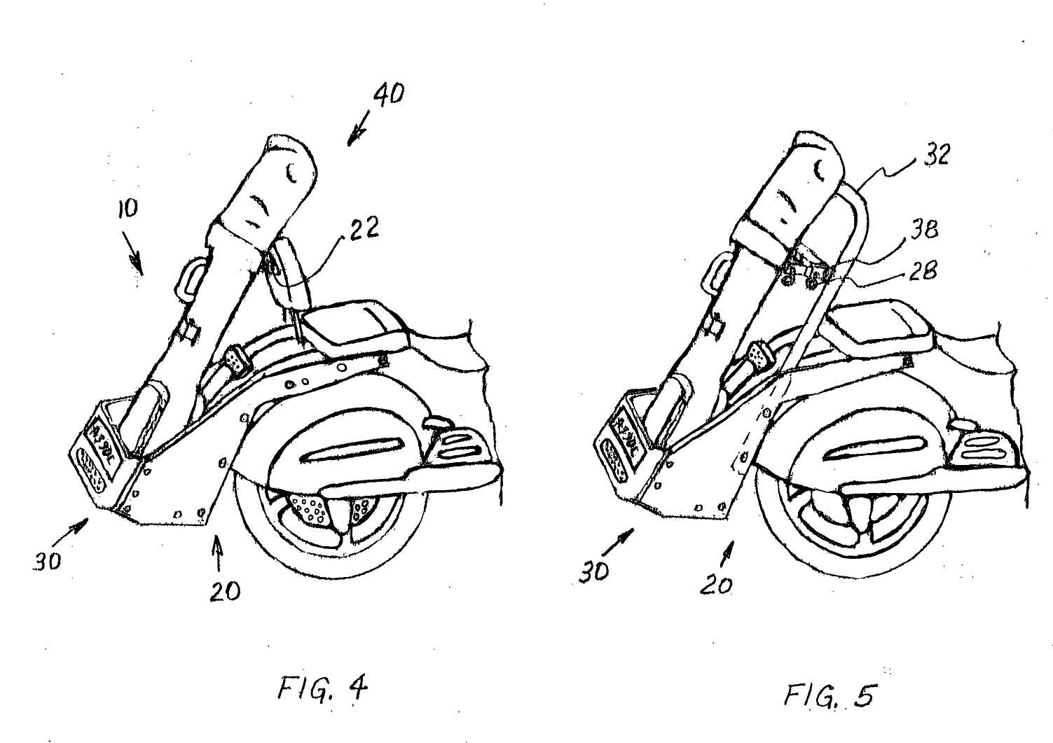

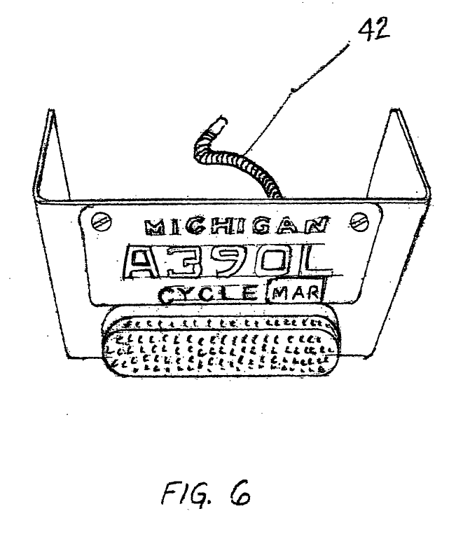

Now reference is made, more particularly, to drawing FIGS. 1 and 2. Illustrated therein is an apparatus, generally designated 10, according to one embodiment of the invention. Such apparatus 10 is used for mounting on the back of a motorcycle for transporting a golf bag.

The apparatus 10 comprises a pair of structural members, generally designated 20, each one of the structural members 20 having a substantially horizontally disposed portion 2 engageable with a respective rear side portion of such motorcycle and a pair or substantially vertically disposed portions 4. There is a box like member, generally designated 30, having a bottom portion 12 for supporting a bottom of such golf bag, a front portion 14 for partially retaining such golf bag adjacent a bottom portion thereof and a pair of side portions 16 engageable with the pair or substantially vertically disposed portions 4 of said structural member 20, such golf bag being further retained adjacent such bottom portion 12 thereof by at least one of the pair of substantially vertically disposed portions 4 of the pair of structural members 20 and the pair of side portions 16 of such box like member 30 serving to retain such bottom portion of such golf bag, and by at least one of the pair of substantially vertically disposed portions 4 of the pair of structural members 20 and at least one of the pair of side portions 16 of the box like member 30 serving to retain such bottom portion of such golf bag.

There is a means, generally designated 40, for supporting an upper portion of such golf bag, said means 40 is engageable with a seat back of such motorcycle. As is evident from the above description this aspect of the invention is applicable to motorcycles that are equipped with a seat back. The means 40 includes a bracket member 22. Although there are a variety of ways that such golf bag could be secured by such means 40 on such seat back, such as by straps similar to those used on a golf carts, or other means, it is presently preferred that such means 40 also further includes another bracket 24 together with a pivotable member 26 between the two brackets. The pivotable member 26 is easily attachable to either bracket 22 or 24 by the use of pull pins 28.

The second aspect of the invention is provided for motorcycles that do not come equipped with a seat back. In this aspect the present invention provides an apparatus 10 engageable with a motorcycle for supporting and carrying a golf bag. The apparatus 10 is very similar to the embodiment of the invention described previously. As with the first aspect the apparatus 10 comprises a pair of structural members, generally designated 20, each one of the structural members 20 having a substantially horizontally disposed portion 2 engageable with a respective rear side portion of such motorcycle and a pair or substantially vertically disposed portions 4. There is a box like member, generally designated 30, having a bottom portion 12 for supporting a bottom of such golf bag, a front portion 14 for partially retaining such golf bag adjacent a bottom portion thereof and a pair of side portions 16 engageable with the pair or substantially vertically disposed portions 4 of said structural member 20, such golf bag being further retained adjacent such bottom portion 12 thereof by at least one of the pair of substantially vertically disposed portions 4 of the pair of structural members 20 and the pair of side portions 16 of such box like member 30 serving to retain such bottom portion of such golf bag, and by at least one of the pair of substantially vertically disposed portions 4 of the pair of structural members 20 and at least one of the pair of side portions 16 of the box like member 30 serving to retain such bottom portion of such golf bag.

Since this aspect of the invention is for motorcycles without seat backs the means for supporting and securing the golf bag is different. In this embodiment there is a means 50 for supporting such upper portion of such golf bag. Such means 50 includes a generally U-shaped member 32. At least one leg 34 of the U-shaped member 32 is angularly positioned between one of the pair of substantially vertically disposed portions 4 of the structural member 20 and adjacent an outer surface of the at least one of pair of substantially vertically disposed portions 4 of the pair of structural members 20 for engagement with an upper portion of such golf bag. Such U-shaped member 32 further includes a horizontal member 36 that engages the two legs 34 of the u-shaped member 32 closely adjacent the U portion of the U-shaped member 32. A bracket 38, for engagement with the pivotable portion 26 of the bracket 24 attached to the golf bag, is mounted on such horizontal member 36.

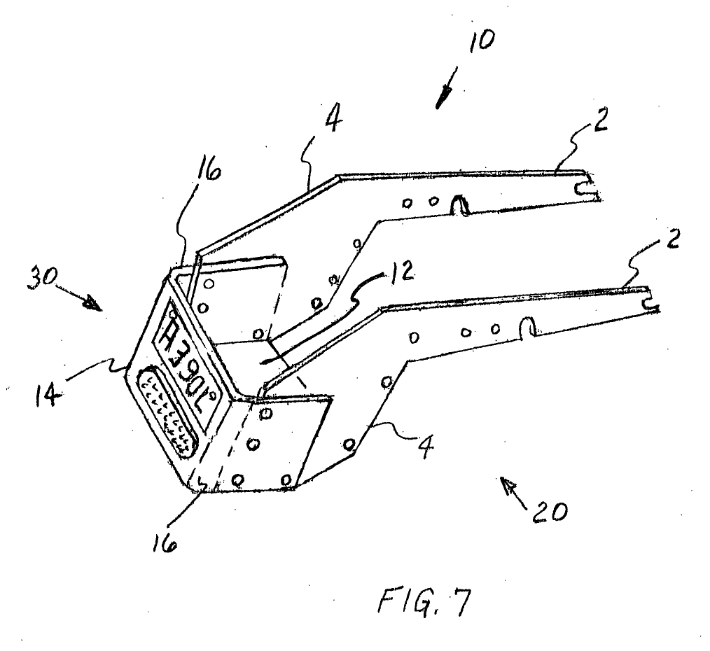

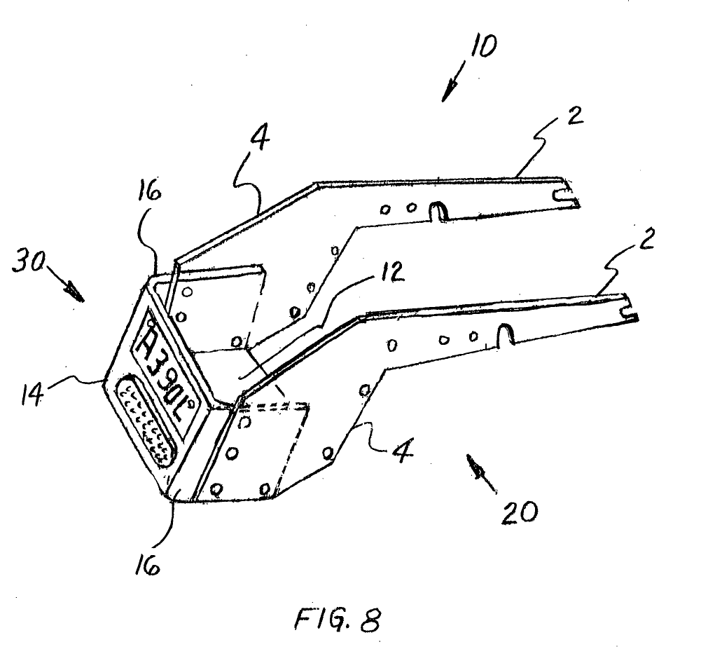

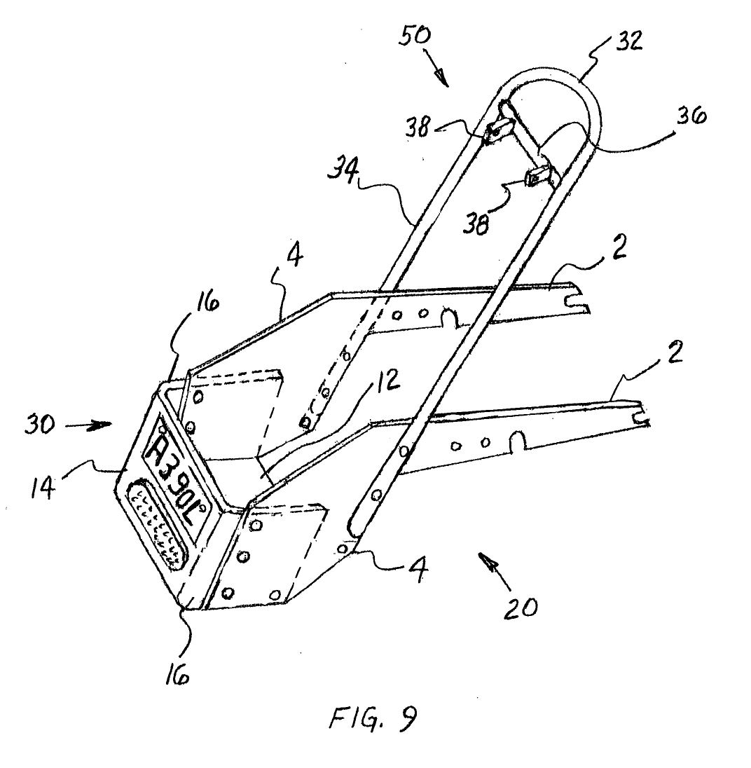

In FIG. 1 the apparatus is shown with the structural members 20 disposed on the outer surface of such box like member 30, while FIG. 7 shows the structural members 20 disposed on an inner surface of the sides 16 of such box-like member 30. FIGS. 8 and 9 show alternate embodiments of the invention.

Although it is only shown that the golf bag is secured by brackets in either embodiment, it is within the scope of the invention that such golf bag can be secured to either the back rest or the U-shaped member by means of a strap similar to what is used on golf carts.

The apparatus 10, bike caddy, is a custom fit accessory that will fit several of the more popular brands of motorcycles such as Harley Davidson, Honda, Suzuki, Victory, etc. The apparatus 10 is mounted directly onto current or existing mounting locations on these motorcycles. Typically all motorcycles have 2-3 bolts that are used to mount the rear fender and rear seat. The present invention utilizes these existing mounting locations. This allows for a couple of items. First, typically, but not in every installation, the system can be mounted onto the motorcycle without “bolting” or installing any new screws onto the motorcycle. This allows for very quick installation and/or removal, usually in less than 90 seconds. The bike caddy also has safety features designed into the system. By mounting the golf bag (or a storage box) in the upright position the invention remains in the direct center line of the bike. By doing so this minimizes any problem that could occur with the handling of the motorcycle. Such would not be the case where the load (golf bag or storage box) was not aligned with the central axis of the motorcycle since the weight would not be distributed evenly.

A second feature that was designed into the invention is with regard to the lighting system. The apparatus 10 of the present invention has provisions to plug or unplug the stop light and running light. A wire harness 42 (shown in FIG. 6) is provided with the system for the stop light and running light to plug into. Thus, the brake lights and running lights are visible all the time even with the golf bag in place.

The invention has a three point mounting system, two mounts are along the fender, on both sides and a third is the top mount that can be mounted directly to the back rest. For motorcycles that do not have a back rest the invention has a mounting tube that connects to the frame of the carrier and goes to the upper mounting position to replace the backrest mount.

Another important feature is the fact that at no time does the storage rack come in contact with any painted surfaces. This allows for the ability of the moto caddy to transport golf clubs or a storage container and not damage any painted surfaces on the motorcycle. While a presently preferred embodiment and alternate embodiments of the present invention have been described in detail above, it should be understood that various other adaptations and/or modifications of the invention can be made by those persons who are particularly skilled in the art without departing from either the spirit of the invention or the scope of the appended claims.

1. An apparatus engageable with a motorcycle for supporting and carrying a golf bag, said apparatus comprising:
(a) a pair of structural members, each one of said structural members having a substantially horizontally disposed portion engageable with a respective rear side portion of such motorcycle and a pair or substantially vertically disposed portions;
(b) a box like member having a bottom portion for supporting a bottom of such golf bag, a front portion for partially retaining such golf bag adjacent a bottom portion thereof and a pair of side portions engageable with said pair of substantially vertically disposed portions of said structural member, such golf bag being further retained adjacent such bottom portion thereof by at least one of said pair of substantially vertically disposed portions of said pair of structural members and said pair of side portions of said box like member serving to retain such bottom portion of such golf bag, and by at least one of said pair of substantially vertically disposed portions of said pair of structural members and at least one of said pair of side portions of said box like member serving to retain such bottom portion of such golf bag; and
(c) a means for supporting an upper portion of such golf bag, said means engageable with a seat back of such motorcycle.

2. The apparatus, according to claim 1, wherein said front portion of said box like member includes a wire harness for engagement with a brake light and running light of such motorcycle.

3. The apparatus, according to claim 1, wherein said front portion of said box like member further includes a mounting area for a motorcycle license plate.

4. The apparatus, according to claim 1, wherein an outer surface of said both of said pair of side portions of said box like member are engageable with an inner surface of said pair of substantially vertically disposed portions of said pair of structural members.

5. The apparatus, according to claim 1, wherein an inner surface of said both of said pair of side portions of said box like member are engageable with an outer surface of said pair of substantially vertically disposed portions of said pair of structural members.

6. The apparatus, according to claim 1, wherein such golf bag is mounted in an upright position on said apparatus in a direct center line of such motorcycle, so as to minimize an effect on handling and steering of such motorcycle.

7. The apparatus, according to claim 1, wherein said apparatus utilizes existing mounting locations on such motorcycle to mount said apparatus.

8. The apparatus, according to claim 1, wherein said means for supporting an upper portion of such golf bag includes a bracket mounted on such backrest of such motorcycle for securing such upper portion of such golf bag thereto.

9. The apparatus, according to claim 8, wherein said means for supporting an upper portion of such golf bag further includes a bracket member mounted on such golf bag for engagement with said bracket mounted on such backrest of such motorcycle for securing such upper portion of such golf bag thereto.

10. An apparatus engageable with a motorcycle for supporting and carrying a golf bag, said apparatus comprising:
(a) a pair of structural members, each one of said structural members having a substantially horizontally disposed portion engageable with a respective rear side portion of such motorcycle and a pair of substantially vertically disposed portions;
(b) a box like member having a bottom portion for supporting a bottom of such golf bag, a front portion for partially retaining such golf bag adjacent a bottom portion thereof and a pair of side portions engageable with said pair of substantially vertically disposed portions of said structural member, such golf bag being further retained adjacent such bottom portion thereof by at least one of said pair of substantially vertically disposed portions of said pair of structural members and said pair of side portions of said box like member serving to retain such bottom portion of such golf bag, and by at least one of said pair of substantially vertically disposed portions of said pair of structural members and at least one of said pair of side portions of said box like member serving to retain such bottom portion of such golf bag; and
(c) a means for supporting an upper portion of said golf bag, said means including a generally U-shaped member, at least one leg of said U-shaped member angularly positioned between one of said pair of substantially vertically disposed portions of said structural member and adjacent an outer surface of said at least one of said pair of substantially vertically disposed portions of said pair of structural members for engagement with an upper portion of such golf bag.

11. The apparatus, according to claim 10, wherein said generally U-shaped member includes a substantially horizontal portion disposed closely adjacent a curved portion of said U-shaped member for securing an upper portion of such golf bag thereto.

12. The apparatus, according to claim 10, wherein said substantially horizontal portion disposed closely adjacent a curved portion of said U-shaped member includes a bracket for engagement with such golf bag.

13. The apparatus, according to claim 12, wherein said means for supporting an upper portion of such golf bag further includes a bracket member mounted on such golf bag for engagement with said bracket mounted on said substantially horizontal portion of said U-shaped member for securing such upper portion of such golf bag thereto.

14. The apparatus, according to claim 10, wherein both legs of said U-shaped member are angularly positioned between said pair of substantially vertically disposed portions of said pair of structural members.

15. The apparatus, according to claim 10, wherein both legs of said U-shaped member are angularly positioned adjacent an outer surface of said pair of substantially vertically disposed portions of said pair of structural members.

16. The apparatus, according to claim 10, wherein said front portion of said box like member includes a wire harness for engagement with a brake light and running light of such motorcycle.

17. The apparatus, according to claim 10, wherein said front portion of said box like member further includes a mounting area for a motorcycle license plate.

18. The apparatus, according to claim 10, wherein an outer surface of said both of said pair of side portions of said box like member are engageable with an inner surface of said pair of substantially vertically disposed portions of said pair of structural members.

19. The apparatus, according to claim 10, wherein an inner surface of said both of said pair of side portions of said box like member are engageable with an outer surface of said pair of substantially vertically disposed portions of said pair of structural members.
